(19) United States
(12) Patent Application Publication
(10) Pub. No.: US 2007/0245858 A1
(43) Pub. Date: Oct. 25, 2007

(54) RETAINER RING FOR WRENCH WITH BOX END

(76) Inventor: Bobby Hu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/379,919

(22) Filed: Apr. 24, 2006

(51) Int. Cl. B25B 13/02; B25B 13/46

(52) U.S. Cl. 81/125; 81/60

(57) ABSTRACT

A wrench includes a box end and a resilient retainer ring. The box end includes an inner periphery having a plurality of corners and defining a hole. An annular groove is defined in an end of the inner periphery. The retainer ring is mounted in the annular groove. The retainer ring includes at least two pressing sections and at least one engaging section. The at least two pressing sections simultaneously press against a bottom wall defining the annular groove such that at least a portion of the at least one engaging section is exposed to at least one of the corners of the inner periphery.

### BACKGROUND OF THE INVENTION

1. Field of the Invention

The present invention relates to a retainer ring for a wrench. More particularly, the present invention relates to a retainer ring for a wrench with a box end for securely retaining a fastener during tightening/loosening of the fastener.

2. Description of the Related Art

A typical wrench or spanner of the type having one or two box ends includes a polygonal inner periphery in the box end. The polygonal inner periphery is engaged with, e.g., a head of a bolt or a nut, allowing the bolt or nut to be tightened or loosened upon turning of the wrench or spanner. However, the bolt head or nut is liable to slip out of the box end during tightening/loosening. Further, it is difficult, undesirable, or even hazardous for a user to place or remove the bolt or nut into or from a small, difficult-to-access space or a dirty or high-temperature environment.

### SUMMARY OF THE INVENTION

In accordance with an aspect of the present invention, a wrench comprises a box end and a resilient retainer ring. The box end includes an inner periphery having a plurality of corners and defining a hole. An annular groove is defined in an end of the inner periphery. The retainer ring is mounted in the annular groove. The retainer ring includes at least two pressing sections and at least one engaging section. The at least two pressing sections simultaneously press against a bottom wall defining the annular groove such that at least a portion of the at least one engaging section is exposed to at least one of the corners of the inner periphery.

Preferably, the inner periphery is polygonal.

In an example, the wrench further comprises a drive member rotatably mounted in the box end. The inner periphery and the annular groove for receiving the retainer ring are defined in the drive member.

Preferably, the at least one engaging section is located radially inward relative to the at least two pressing sections.

Preferably, the retainer ring includes two distal ends spaced by an opening that is smaller than one third of a circumference of a circle on which the retainer ring locates.

Preferably, the retainer ring includes two distal ends spaced by an opening. Each distal end forms an associated one of the at least two pressing sections.

Preferably, the retainer ring further includes a third pressing section opposed to the opening.

In an example, the number of the at least one engaging section is two, and the two engaging sections of the retainer ring are respectively located on two sides of the third pressing section.

The hole of the wrench is adapted for receiving an object to be driven by the wrench. The object is stopped by the exposed portion of the at least one engaging section and thus retained in the hole, allowing rapid driving of the object.

The retainer ring may be movable to a position surrounding the object by applying a force to the wrench, allowing the object to be securely clamped by the retainer ring.

The retainer ring may be movable across the object by applying another force larger than said force to the wrench.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of a wrench with a retainer ring in accordance with the present invention.

FIG. 2 is an exploded perspective view of the wrench in FIG. 1.

FIG. 3 is a sectional view of an end of the wrench in FIG. 1.

FIG. 4 is a sectional view similar to FIG. 3, wherein the retainer ring is in an angular position 30 degrees ahead of that in FIG. 3.

FIG. 5 is a sectional view similar to FIG. 3, wherein the retainer ring is in an angular position 50 degrees ahead of that in FIG. 3.

FIG. 6 is a partially sectioned plan view of a portion of the wrench coupled with a fastener.

FIG. 7 is a side view, partly sectioned, of the wrench and the fastener in FIG. 6.

FIG. 8 is a view similar to FIG. 6, illustrating another use of the retainer ring.

FIG. 9 is a view similar to FIG. 7, illustrating another use of the retainer ring.

FIG. 10 is a sectional view illustrating use of the wrench in a difficult-to-access space.

FIG. 11 is a sectional view illustrating a further use of the wrench in accordance with the present invention.

FIG. 12 is a sectional view illustrating use of the wrench with a through-type socket.

FIG. 13 is an exploded perspective view illustrating use of the wrench with an adaptor.

FIG. 14 is a perspective view illustrating use of the retainer ring in accordance with the present invention with a wrench of another type.

FIG. 15 is an exploded perspective view of the wrench in FIG. 14.

### DETAILED DESCRIPTION OF THE PREFERRED EMBODIMENTS

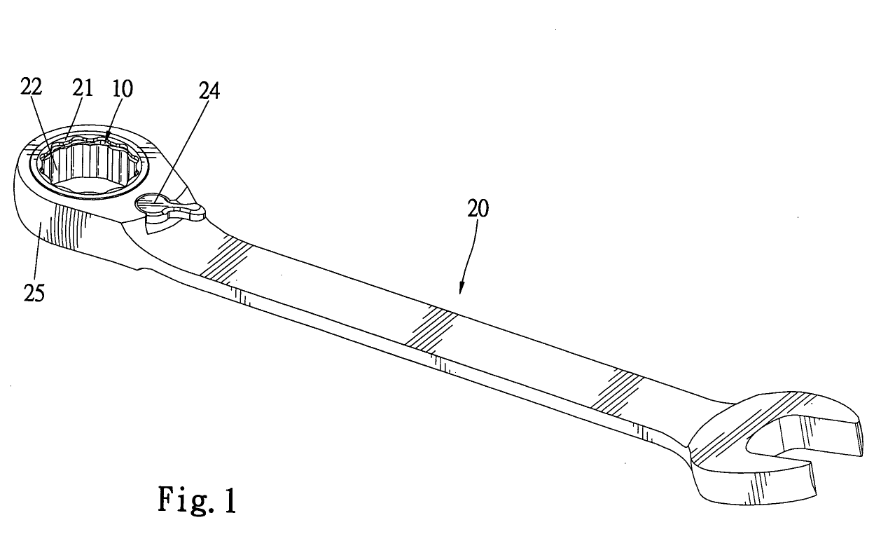

Referring to FIGS. 1 through 3, an embodiment of a wrench 20 in accordance with the present invention comprises a box end 25 and a retainer ring 10 mounted in the box end 25. In this embodiment, a drive member 21 is rotatably mounted in the box end 25. The drive member 21 includes an inner periphery that defines a hole 22 for coupling with an object, such as a fastener, a through-type socket, an adaptor, etc. The inner periphery may be polygonal and includes a plurality of corners. An annular groove 23 is defined in an end of the inner periphery. And the retainer ring 10 is received in the annular groove 23.

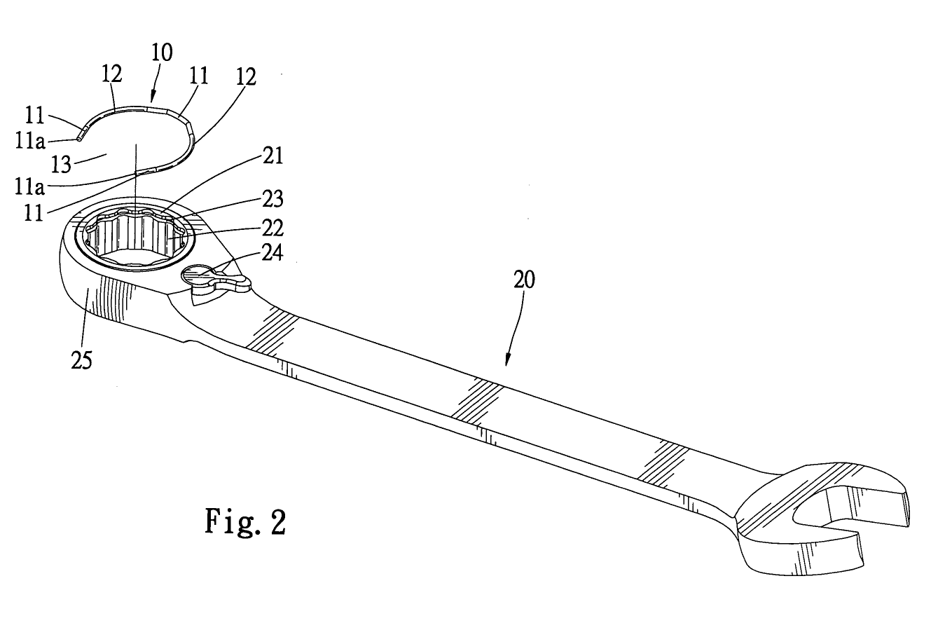

The retainer ring 10 is a substantially C-shaped resilient ring having an opening 13 between two distal ends 11a thereof, as shown in FIG. 2. The retainer ring 10 includes at least two pressing sections 11 that press against a bottom wall defining the annular groove 23 and at least one engaging section 12. In this embodiment, the retainer ring 10 includes two engaging sections 12 and three pressing sections 11 two of which are located on the distal ends 11a of the retainer ring 10. The remaining, central pressing section 11 is opposite to the opening 13 of the retainer ring 10. The engaging sections 12 are respectively located on two sides of the central pressing section 11. Preferably, the engaging sections 12 are located radially inward relative to the pressing sections 11.

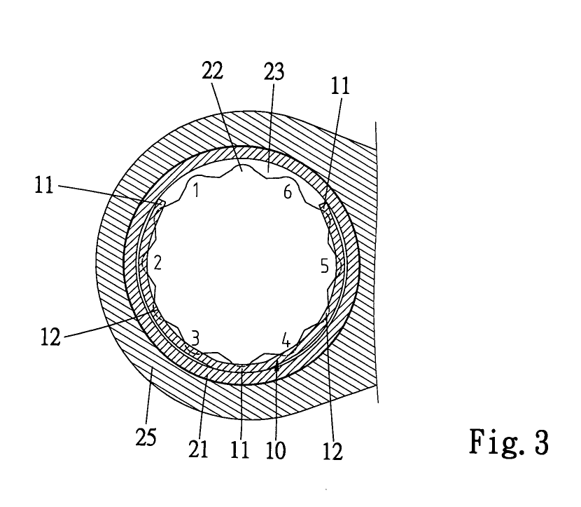

As illustrated in FIG. 3, when the retainer ring 10 is mounted in the annular groove 23 of the wrench 20, the pressing sections 11 simultaneously press against the bottom wall defining the annular groove 23 of the wrench 20 such that portions of the engaging sections 12 are respectively exposed to the second corner and the fourth corner of the hole 22 of the drive member 21. Thus, the retainer ring 10 is securely retained in the annular groove 23 of the wrench 20 without the risk of wobbling and/or displacement of the retainer ring 10.

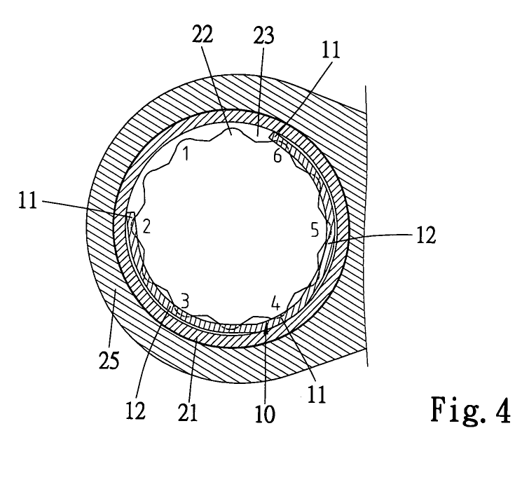

Referring to FIG. 4, when the retainer ring 10 is engaged in the annular groove 23 in another position (e.g., the retainer ring 10 is in an angular position 30 degrees ahead of that in FIG. 3), the retainer ring 10 is securely retained in the annular groove 23 of the wrench 20 without the risk of wobbling and/or displacement, as the pressing sections 11 simultaneously press against the bottom wall defining the annular groove 23 of the wrench 20 and portions of the engaging sections 12 are respectively exposed to the third corner and the fifth corner of the hole 22 of the drive member 21.

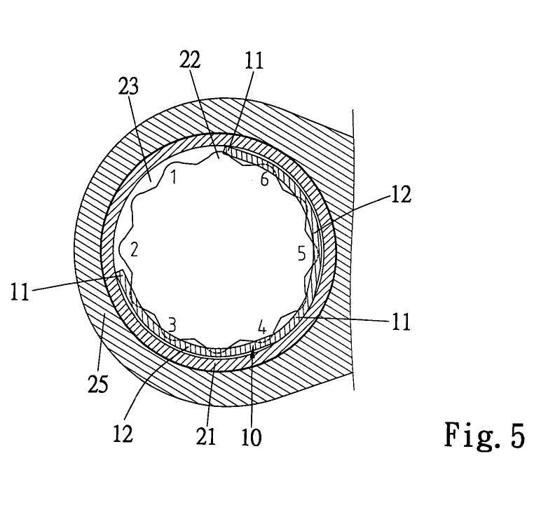

Referring to FIG. 5, when the retainer ring 10 is engaged in the annular groove 23 in another position (e.g., the retainer ring 10 is in an angular position 50 degrees ahead of that in FIG. 3), the retainer ring 10 is securely retained in the annular groove 23 of the wrench 20 without the risk of wobbling and/or displacement, as the pressing sections 11 simultaneously press against the bottom wall defining the annular groove 23 of the wrench 20 and portions of the engaging sections 12 are respectively exposed to the third corner and the sixth corner of the hole 22 of the drive member 21.

It is thus noted that at least a portion of each engaging section 12 is exposed to a corner of the hole 22 of the drive member 21 regardless of the angular position of the retainer ring 10 in the annular groove 23 of the wrench 20. Preferably, the opening 13 of the retainer ring 10 is smaller than one third of a circumference of a circle on which the retainer ring 10 locates.

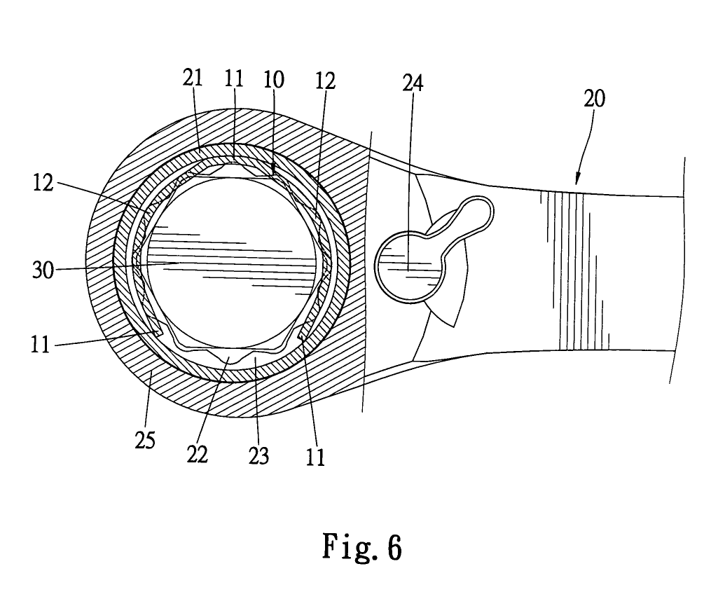

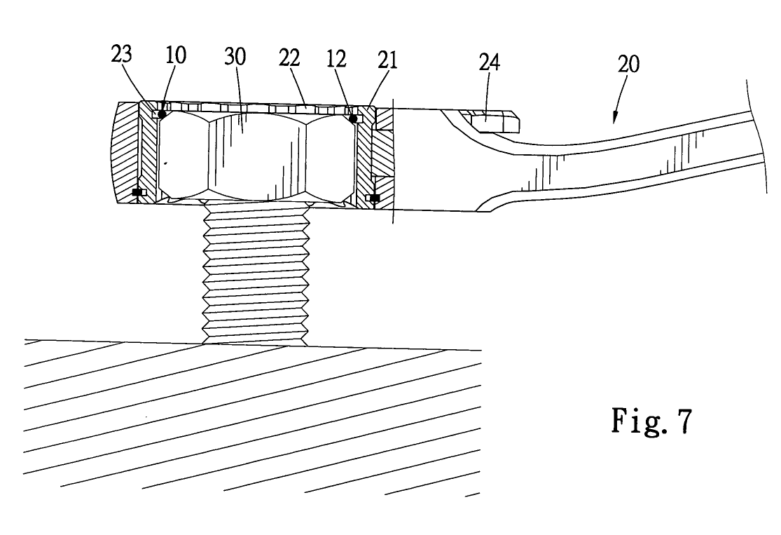

Referring to FIGS. 6 and 7, when the wrench 20 is used to drive a fastener 30, the fastener 30 is engaged in the hole 22 of the drive member 21. Undesired disengagement of the fastener 30 from the hole 22 of the drive member 21 is avoided by the exposed portions of the engaging sections 12 of the retainer ring 10. Thus, the user may tighten/loosen the fastener 30 rapidly in a secure, reliable manner. It is noted that the wrench 20 may include a switch member 24 to change the driving direction and free rotation direction of the wrench 20, which is conventional.

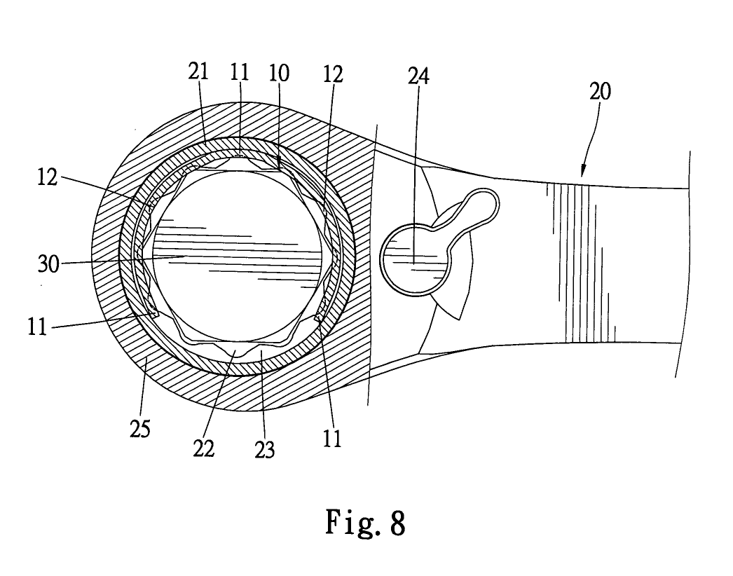

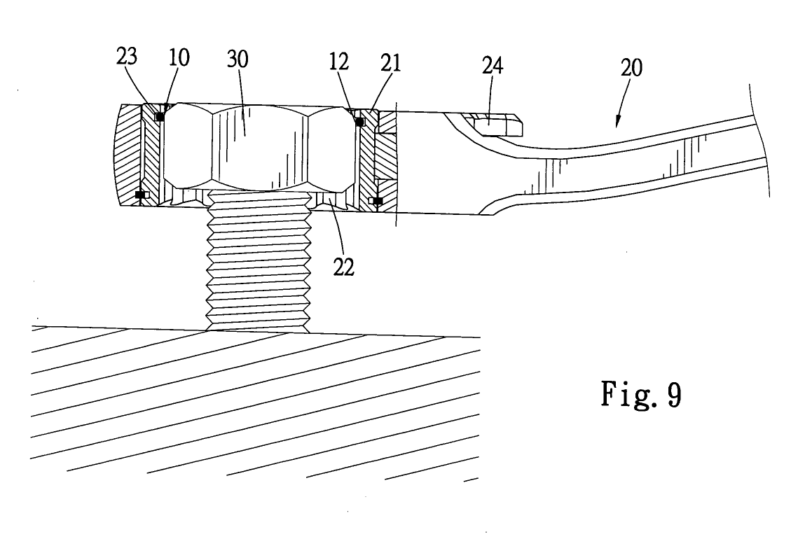

Referring to FIGS. 8 and 9, the user may apply a larger force to the wrench 20 to force the exposed portions of the engaging sections 12 to move across a distance on an outer perimeter (not labeled) of the fastener 30. The retainer ring 10 expands radially outward such that the pressing sections 11 exert a larger force to the bottom wall defining the annular groove 22 of the drive member 21, and the fastener 30 is securely clamped by the engaging portions 12 due to reactive force from the pressing sections 11. This allows the fastener 30 to be removed together with the wrench 20 after loosening operation, which is particularly advantageous when the fastener 30 is in a difficult-to-access space or in a dirty or high-temperature environment. Of course, the fastener 30 can be firstly coupled in the hole 22 of the drive member 21 and then carried by the wrench 20 to the desired location for tightening purposes.

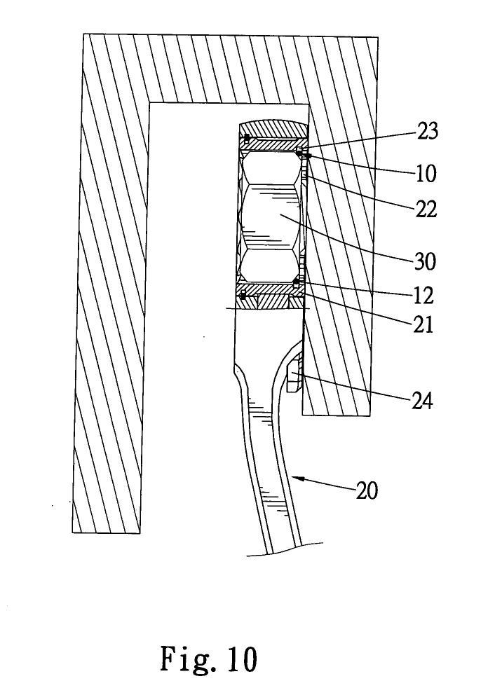

Referring to FIG. 10, the wrench 20 can be coupled with a fastener 30 in a difficult-to-access space in an upside-down state compared to that in FIG. 7.

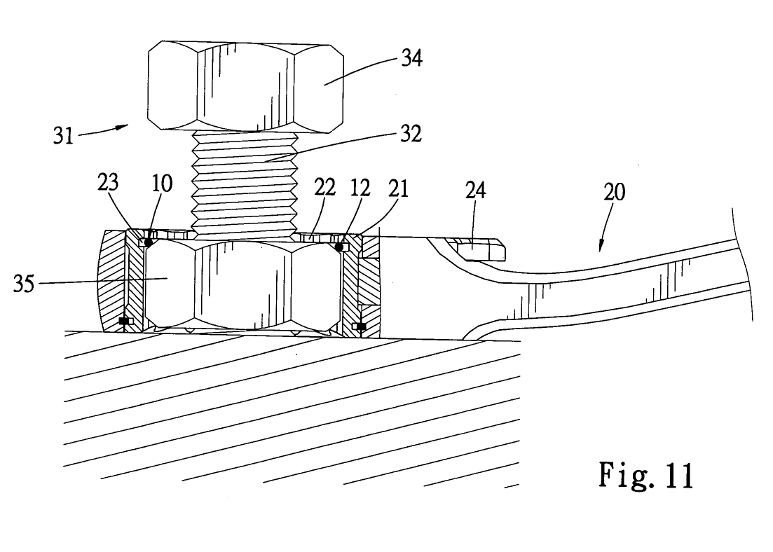

FIG. 11 illustrates another use of the wrench 20 in accordance with the present invention. In a case that a nut 35 is mounted around a shank 32 of a bolt 31, the user may apply a larger force to forcibly move the exposed portions of the engaging sections 12 across the whole outer perimeter (not labeled) of a head 34 of the bolt 31, allowing the nut 35 to be coupled in the hole 22 of the drive member 21 for subsequent tightening/loosening operation. After tightening/loosening operation, the wrench 20 can be forcibly passed through the head 34 of the bolt 31 in a reverse direction.

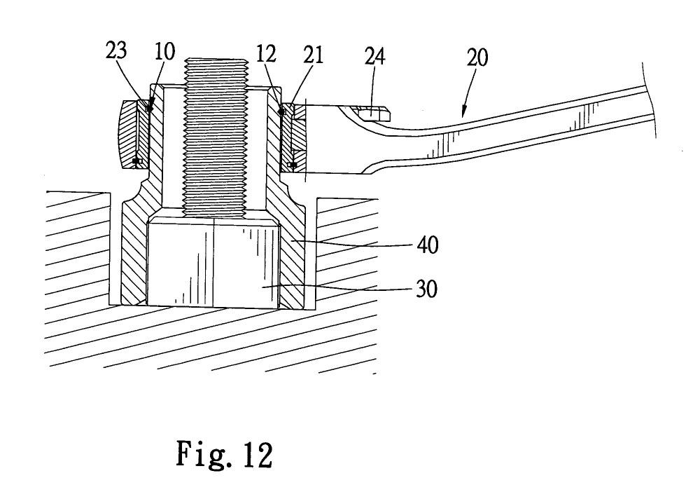

FIG. 12 illustrates use of the wrench 20 in accordance with the present invention with a through-type socket 40 for driving a fastener 30 in a recessed area.

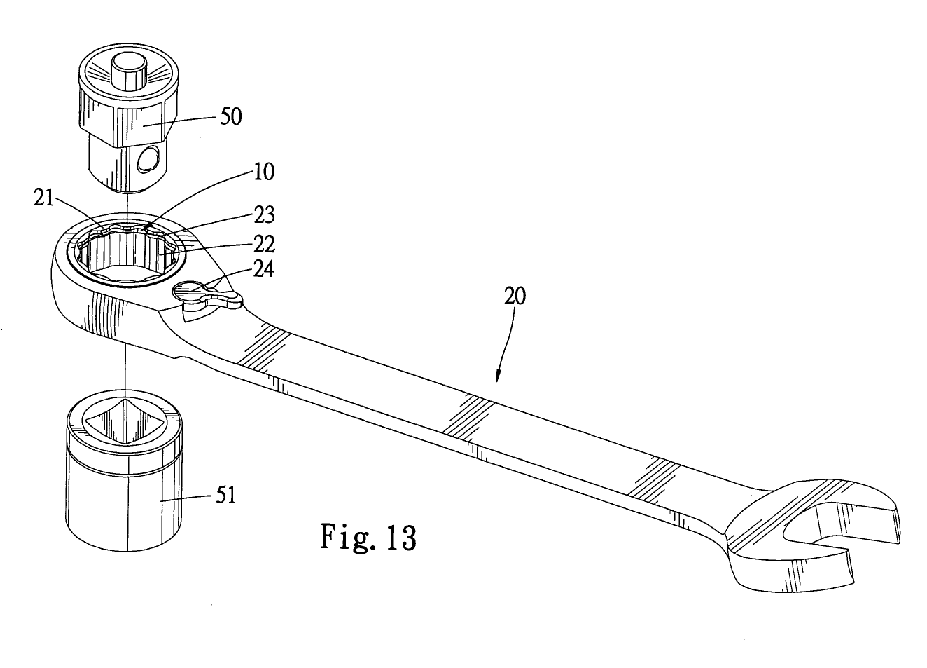

FIG. 13 illustrates use of the wrench 20 in accordance with the present invention with an adaptor 50 for driving a socket 51.

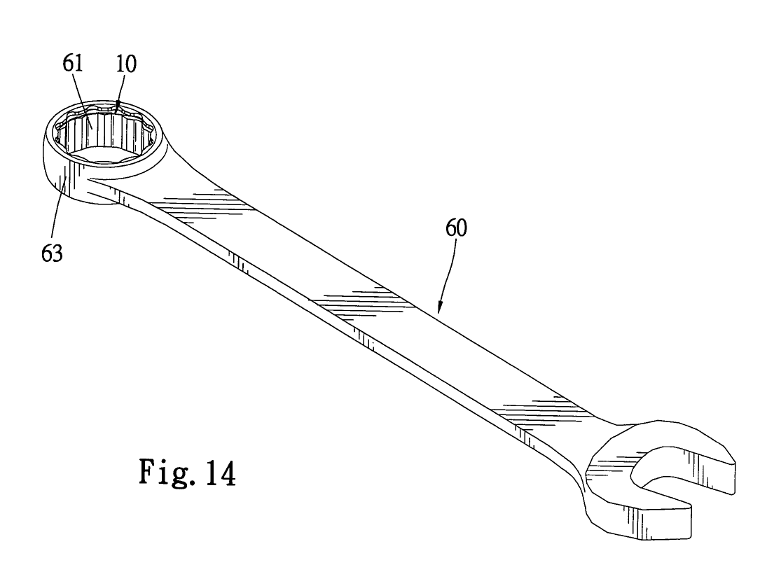

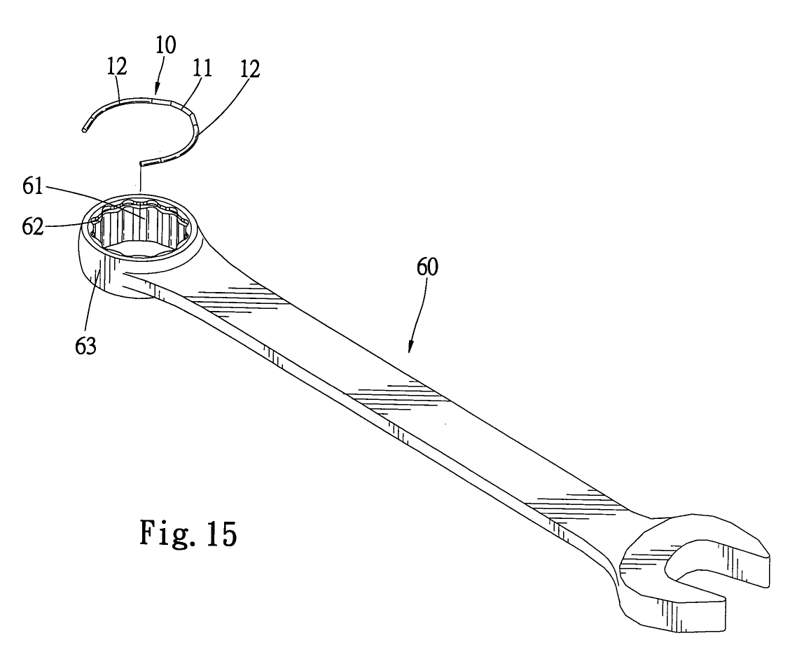

FIGS. 14 and 15 illustrate use of the retainer ring 10 in accordance with the present invention with a wrench 60 of another type. In this embodiment, the wrench 60 comprises a box end 63 having an inner periphery that defines a hole 61 for coupling with an object, such as a fastener, a through-type socket, an adaptor, etc. An annular groove 62 is defined in an end of the inner periphery. And the retainer ring 10 is received in the annular groove 62. This embodiment provides the same advantages of the embodiment of FIG. 1 except for the change in the driving direction and the free rotating direction of the wrench 20.

It is noted that the numbers and the shapes of the pressing sections 11 and the engaging sections 12 of the retainer ring 10 in accordance with the present invention may vary according to needs.

Although specific embodiments have been illustrated and described, numerous modifications and variations are still possible without departing from the essence of the invention. The scope of the invention is limited by the accompanying claims.

1. A wrench comprising a box end and a resilient retainer ring, the box end including an inner periphery having a plurality of comers and defining a hole, an annular groove being defined in an end of the inner periphery, the retainer ring being mounted in the annular groove, the retainer ring having cross sections of a constant size, the retainer ring including at least two pressing sections and at least one engaging section located intermediate the at least two pressing sections, with said at least one engaging section being located radially inward relative to said at least two pressing sections, said at least two pressing sections simultaneously pressing against a bottom wall defining the annular groove while at least a portion of said at least one engaging section is spaced from the bottom wall defining the annular groove and is exposed to at least one of the comers of the inner periphery.

2. The wrench as claimed in claim 1, with the inner periphery being polygonal.

3. The wrench as claimed in claim 1, with the wrench further comprising a drive member rotatably mounted in the box end, and with said inner periphery and said annular groove for receiving the retainer ring being defined in the drive member.

4. (canceled)

5. The wrench as claimed in claim 1, with the retainer ring including two distal ends spaced by an opening that is smaller than one third of a circumference of a circle on which the retainer ring is located.

6. The wrench as claimed in claim 1, with the retainer ring including two distal ends spaced by an opening, each said distal end forming an associated one of said at least two pressing sections.

7. The wrench as claimed in claim 6, with the retainer ring further including a third pressing section opposed to the opening.

8. The wrench as claimed in claim 7, with the number of said at least one engaging section is two, with the two engaging sections of the retainer ring being respectively located on two sides of the third pressing section.

9. The wrench as claimed in claim 1, with the hole of the wrench being adapted for receiving an object to be driven by the wrench, said object being stopped by said exposed portion of said at least one engaging section and thus retained in the hole, allowing rapid driving of the object.

10. The wrench as claimed in claim 9, with the retainer ring being movable to a position surrounding said object by applying a force to the wrench, allowing said object to be securely clamped by the retainer ring.

11. The wrench as claimed in claim 10, with the retainer ring being movable across said object by applying another force larger than said force to the wrench.

12. The wrench as claimed in claim 8, with the hole of the wrench being adapted for receiving an object to be driven by the wrench, said object being stopped by said exposed portion of said at least one engaging section and thus retained in the hole, allowing rapid driving of the object.

13. The wrench as claimed in claim 12, with the retainer ring being movable to a position surrounding said object by applying a force to the wrench, allowing said object to be securely clamped by the retainer ring.

14. The wrench as claimed in claim 13, with the retainer ring being movable across said object by applying another force larger than said force to the wrench.

15. A wrench comprising a box end and a retainer ring, a drive member being rotatably mounted in the box end including an inner periphery having a plurality of comers and defining a hole, an annular groove being defined in an end of the inner periphery, the retainer ring being mounted in the annular groove, the retainer ring having cross sections of a constant size, the retainer ring including at least two pressing sections and at least one engaging section located intermediate the at least two pressing sections, with said at least one engaging section being located radially inward relative to said at least two pressing sections, said at least two pressing sections simultaneously pressing against a bottom wall defining the annular groove while at least a portion of said at least one engaging section is spaced from the bottom wall defining the annular groove and is exposed to at least one of the comers of the inner periphery, the hole of the wrench being adapted for receiving an object to be driven by the wrench, said object being stopped by said exposed portion of said at least one engaging section and thus retained in the hole, allowing rapid driving of the object, the retainer ring being movable to a position surrounding said object by applying a force to the wrench, allowing said object to be securely clamped by the retainer ring, and with the retainer ring being movable across said object by applying another force larger than said force to the wrench.

16. (canceled)

17. The wrench as claimed in claim 15, with the retainer ring including two distal ends spaced by an opening that is smaller than one third of a circumference of a circle on which the retainer ring locates.

18. The wrench as claimed in claim 15, with the retainer ring including two distal ends spaced by an opening, each said distal end forming an associated one of said at least two pressing sections.

19. The wrench as claimed in claim 18, with the retainer ring further including a third pressing section opposed to the opening.

20. The wrench as claimed in claim 19, with the number of said at least one engaging section is two, with the two engaging sections of the retainer ring being respectively located on two sides of the third pressing section.
